(19) United States
(12) Patent Application Publication
(10) Pub. No.: US 2009/0280281 A1
(43) Pub. Date: Nov. 12, 2009

(54) HOUSING AND METHOD FOR MAKING THE SAME

(75) Inventors: Che-Yuan Hsu, Shindian (TW); Fu-Keng Yang, Shindian (TW); Cheng-Wen Su, Shindian (TW); Yi-Qiang Xu, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/432,888

(22) Filed: Apr. 30, 2009

(30) Foreign Application Priority Data
May 9, 2008 (CN) 200810301514.5

(51) Int. Cl. B32B 1/02; B32B 27/08; B29C 45/14

(52) U.S. Cl. 428/35.8; 428/35.7; 264/279; 264/132

(57) ABSTRACT

A housing includes a substrate, a decorative layer attached to the substrate, a transparent plastic film covering the decorative layer, and a metallic plastic film made of a mixture of metal powder and transparent plastic. The metallic plastic film is attached to the transparent plastic film.

### CROSS-REFERENCE TO RELATED APPLICATIONS

This application is related to a co-pending U.S. patent application (Attorney Docket No. US20141), entitled “HOUSING AND METHOD FOR MAKING THE SAME”. Both applications have the same assignee and were concurrently filed.

### BACKGROUND

1. Technical Field

The present invention relates to housings for mobile device and, particularly, to a housing for mobile devices with soft surface.

2. Description of Related Art

Mobile devices, such as mobile telephones, personal digital assistants, or MP3 players, enable consumers to enjoy the convenience of high technology services, anytime and at virtually any location. These mobile devices often employ a variety of decorative housings to attract consumers. The decorative housings for mobile devices are typically made of molded plastic articles. A metallic appearance of these housings is attractive to consumers. Electroplating is effective process for giving the molded plastic articles a metallic appearance.

However, electroplating molded plastic articles requires complicated processes, such as chemical plating and noble metal plating, which decrease the product efficiency of the molded plastic articles and increase the cost of the molded plastic articles.

Therefore, there is room for improvement within the art.

### BRIEF DESCRIPTION OF THE DRAWINGS

Many aspects of the housing can be better understood with reference to the following drawings. The components in the drawings are not necessarily to scale, the emphasis instead being placed upon clearly illustrating the principles of the present housing. Moreover, in the drawings, like reference numerals designate corresponding parts throughout the following view.

FIG. 1 is a cut-away view of an exemplary embodiment of the present housing.

FIG. 2 is a flow chart of an exemplary embodiment of a method for making the housing shown in FIG. 1.

FIG. 3 is a cut-away view of an exemplary embodiment of two rollers during making the housing shown in FIG. 1.

### DETAILED DESCRIPTION

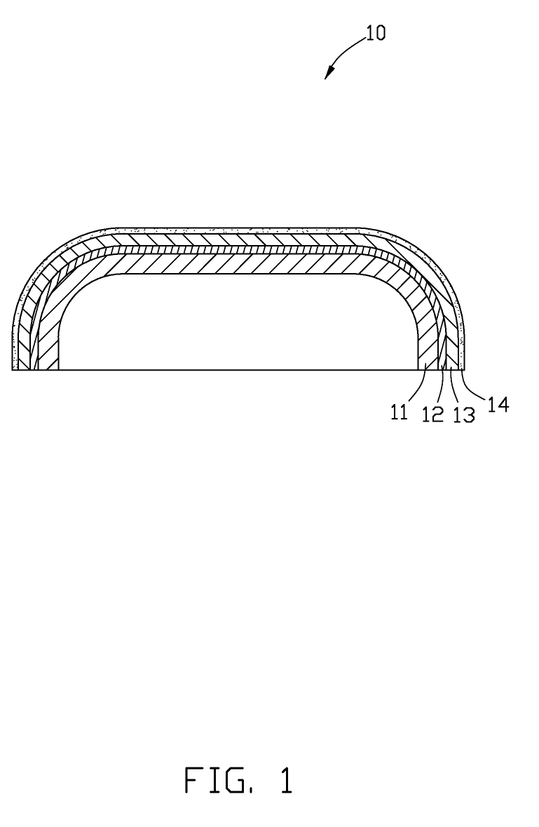

Referring to FIG. 1, a housing 10 of a present exemplary embodiment includes a substrate 11, a decorative layer 12 attached to the substrate 11, a transparent plastic film 13 covering the decorative layer 12, and a metallic plastic film 14 attached to the transparent plastic film 13 on an opposite surface to the decorative layer 12.

The substrate 11 may be made of plastic material selected from a group consisting of polyethylene, polycarbonate, acrylonitrile butadiene styrene, poly methyl methacrylate, and poly ethylene terephthalate.

The decorative layer 12 is an ink coating formed by screen printing and may define a pattern.

The transparent plastic film 13 is made of plastic material selected from a group consisting of polycarbonate, poly ethylene terephthalate, poly methyl methacrylate, and poly lactic acid. The transparent plastic film 13 may be firstly coated with the decorative layer 12. Ultimately, the decorative layer 12 is attached to the substrate 11 in such manner that the decorative layer 12 is sandwiched between the substrate 11 and the transparent plastic film 13.

The metallic plastic film 14 is made of a mixture of metal powder and transparent plastic. The transparent plastic is one of poly propylene and poly amide. The metallic plastic film 14 covers and is attached to the transparent plastic film 13. The metal powder is selected from a group consisting of silver, copper, aluminum, and their alloys. The metal powder is dispersed and uniformly distributed in the metallic plastic film 14, thereby giving the metallic plastic film 14 a metallic appearance.

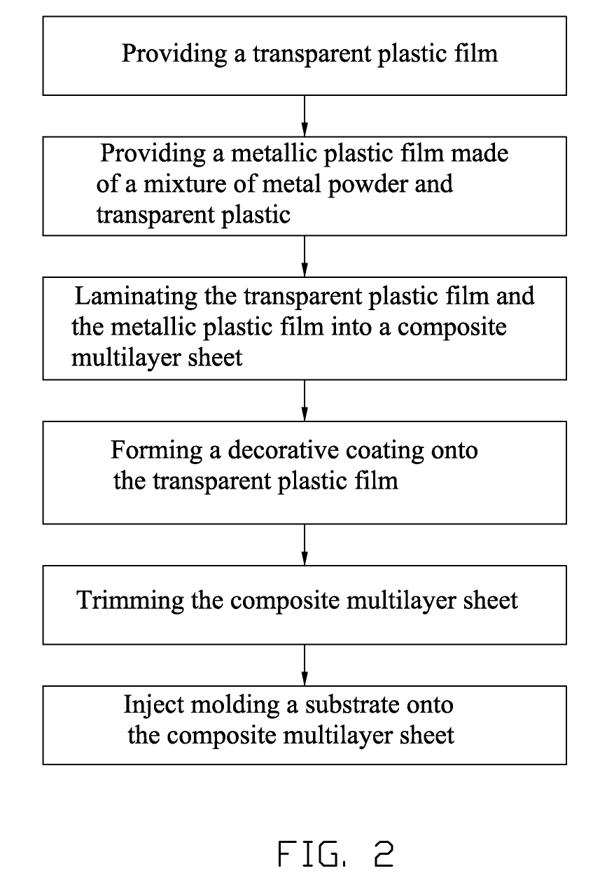

Referring to FIG. 2, a method of an exemplary embodiment for making the housing 10 may include the following steps S100 to S600.

In step S100, the transparent plastic film 13 is provided.

In step S200, the metallic plastic film 14 is provided.

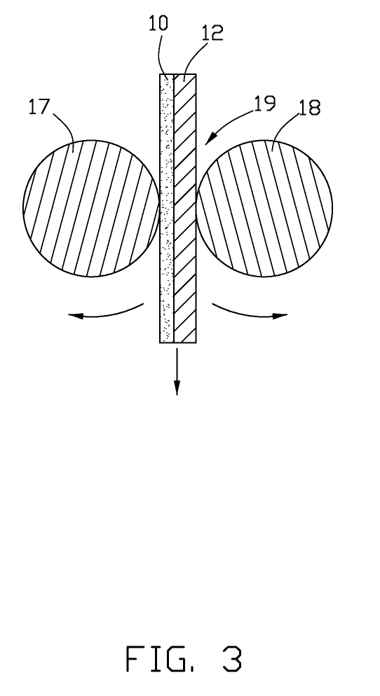

In step 300, referring to FIG. 3, the transparent plastic film 13 and the metallic plastic film 14 are laminated together by using two rollers 17 and 18 to form a composite multilayer sheet. The rollers 17 and 18 rotate in opposite directions. In an exemplary embodiment, the roller 17 is clockwise rotated, with the roller 18 being counterclockwise rotated. The rollers 17 and 18 define a gap 19 therebetween. The width of the gap 19 is slightly smaller than an aggregate thickness of the transparent plastic film 13 and the metallic plastic film 14. The transparent plastic film 13 and the metallic plastic film 14 then pass through the gap 19 and are laminated by the rollers 17 and 18 into a composite multilayer sheet.

In step 400, the decorative coating 12 is screen printed, using ink, on the surface of the transparent plastic film 13 opposite to the metallic plastic film 14.

In step 500, the composite multilayer sheet is trimmed into a desired shape.

In step 600, the trimmed composite multilayer sheet is placed into an injection mold. A melted plastic selected from a group consisting of polyethylene, polycarbonate, acrylonitrile butadiene styrene, poly methyl methacrylate, and poly ethylene terephthalate is then injected onto the composite multilayer sheet, thereby forming the substrate 11, with the decorative layer 12 being sandwiched between the substrate 11 and the transparent plastic film 13.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A housing, comprising:
a substrate;
a decorative layer attached to the substrate;
a transparent plastic film covering the decorative layer; and
a metallic plastic film comprising a mixture of metal powder and transparent plastic, the metallic plastic film attached to the transparent plastic film.

2. The housing as claimed in claim 1, wherein the substrate is made of plastic selected from a group consisting of polyethylene, polycarbonate, acrylonitrile butadiene styrene, poly methyl methacrylate, and poly ethylene terephthalate.

3. The housing as claimed in claim 1, wherein the decorative layer is an ink coating.

4. The housing as claimed in claim 1, wherein the transparent plastic film is made of clear plastic selected from a group consisting of polycarbonate, poly ethylene terephthalate, poly methyl methacrylate, and poly lactic acid.

5. The housing as claimed in claim 1, wherein the transparent plastic contained in the metallic plastic film is one of poly propylene and poly amide.

6. The housing as claimed in claim 1, wherein the metal powder is selected from a group consisting of silver, copper, aluminum, and their alloys.

7. The housing as claimed in claim 1, wherein the metal powder is dispersed and uniformly distributed in the metallic plastic film.

8. A method for making a housing, comprising:
providing a transparent plastic film;
providing a metallic plastic film made of a mixture of metal powder and transparent plastic;
laminating the transparent plastic film and the metallic plastic film into a composite multilayer sheet;
forming a decorative coating onto the transparent plastic film; and
injection molding a substrate onto the composite multilayer sheet, with the decorative layer sandwiched between the substrate and the transparent plastic film.

9. The method as claimed in claim 8, wherein the substrate is made of plastic selected from a group consisting of polyethylene, polycarbonate, acrylonitrile butadiene styrene, poly methyl methacrylate, and poly ethylene terephthalate.

10. The method as claimed in claim 8, wherein the decorative layer is formed by screen printing.

11. The method as claimed in claim 8, wherein the transparent plastic film is made of clear plastic selected from a group consisting of polycarbonate, poly ethylene terephthalate, poly methyl methacrylate, and poly lactic acid.

12. The method as claimed in claim 8, wherein the transparent plastic contained in the metallic plastic film is one of poly propylene and poly amide.

13. The method as claimed in claim 8, wherein the metal powder is dispersed and uniformly distributed in the metallic plastic film.

14. The method as claimed in claim 8, wherein the lamination of the transparent plastic film and the metallic plastic film is carried out by using two rotatable rollers, the rollers defining a gap therebetween, a width of the gap being slightly smaller than an aggregate thickness of the transparent plastic film and the metallic plastic film.
